(19) United States
(12) Patent Application Publication
(10) Pub. No.: US 2013/0040112 A1
(43) Pub. Date: Feb. 14, 2013

(54) ORNAMENT HAVING A DECORATIVE SEAL AND METHOD FOR MANUFACTURING SAME

(71) Applicant: Jong-Moon Yoon, Seoul (KR)

(72) Inventor: Jong-Moon Yoon, Seoul (KR)

(21) Appl. No.: 13/641,241

(22) PCT Filed: Apr. 15, 2011
(86) PCT No.: PCT/KR2011/002723

§ 371 Date: Oct. 30, 2012

(30) Foreign Application Priority Data
Apr. 16, 2010 (KR) 10-2010-0035524

(51) Int. Cl. B44C 1/22; B24B 1/00; B23P 17/04; A47G 35/00; B44C 1/24

(52) U.S. Cl. 428/172; 428/156; 428/542.2; 83/861; 72/362; 29/428; 451/28

(57) ABSTRACT

To produce an original work of art in which intrinsic characteristics such as the artistry and creativity of a seal itself can be fully expressed, provided is an ornament including: a decorative seal portion in which a decorative seal is formed; and an auxiliary decorative portion in which an auxiliary decoration is formed, and which is arranged around the decorative seal portion. The decorative seal is selectively formed in the decorative seal portion in accordance with the purpose of decoration or a consumer's taste, and the auxiliary decoration having a variety of designs is formed in the auxiliary decorative portion manually or by means of a mold.

### TECHNICAL FIELD

The present invention relates to an ornament formed to have a decoration of a seal design or the like carved or patterned thereon, and more particularly, to an ornament in which an auxiliary decoration is first formed around a decorative seal, and then the decorative seal is formed through selective carving or patterning in accordance with the purpose of decoration or a consumer's selection, and to a method for manufacturing same.

### BACKGROUND ART

A seal is a social mode of self expression functioning as a keepsake, and seals are becoming more sophisticated with diversified designs over time. The social need and importance of the seal has been stressed until today to a point that cannot be ignored for human living, and the seal also plays an important role socially and legally in modern society.

Such seals are manufactured by carving names or company names, or distinctively shaped patterns in a special writing style or a distinctive form in a material for a seal such as wood, jade, stone, animal bone, metal, or precious metals from gold to silver.

However, because a seal is something that is completed by a professional seal maker who uses a high level of skill to creatively and precisely craft the seal, the seal may not only be used as a traditional social or legal authenticating means, but may also be used as a unique work of art due to the intrinsic artistry or creativity of the seal itself.

### DISCLOSURE

### Technical Problem

Accordingly, the present invention provides a decorative seal manufactured with a seal design or the like formed thereon so as to be elevated to an original work of art which fully expresses the intrinsic characteristics of a seal such as artistry and creativity, and also provides a method for manufacturing an ornament with such a decorative seal formed thereon.

### Technical Solution

In order to achieve the above object, the present invention provides an ornament having a decorative seal and including: a decorative seal portion on which the decorative seal is formed; and an auxiliary decorative portion on which an auxiliary decoration is formed, and being formed around the decorative seal portion, wherein the decorative seal is formed on the decorative seal portion by selectively carving or patterning according to a decorative purpose or a consumer's taste, and the auxiliary decoration of various designs is formed on the auxiliary decorative portion by carving or patterning manually or by means of a mold.

The ornament having a decorative seal according to the present invention includes: a main material for forming a decorative portion; and an auxiliary material attached to and supporting the main material.

In the ornament having a decorative seal according to the present invention, the main material and the auxiliary material are die plates which are formed of a precious metal or a metal material or a material selected according to a consumer's taste.

Also, to solve another problem of the present invention as described above, a method for manufacturing an ornament having a decorative seal is provided, the method including: a step of forming an auxiliary decorative portion on which an auxiliary decoration is to be formed having various patterns around the decorative seal; a step of forming the auxiliary decoration on the auxiliary decorative portion by carving or patterning manually or by means of a mold; a step of forming a decorative seal portion for forming the decorative seal within the ornament; and a step of forming the decorative seal on the decorative seal portion by selectively carving or patterning according to a decorative use or a consumer's taste.

The method for manufacturing an ornament having a decorative seal according to the present invention further includes a step of coupling a main material for forming the decorative portion, with an auxiliary material for attaching to and supporting the main material.

In the method for manufacturing an ornament having a decorative seal according to the present invention, the main material and the auxiliary material are formed as die plates formed of a precious metal or a metal material or a material selected according to a consumer's taste.

The method for manufacturing an ornament having a decorative seal according to the present invention further includes a step of sanding a surface of the main material on which the decorative portions are formed.

### Advantageous Effects

According to the present invention, a decorative seal material manufactured with a decorative seal formed thereon may be provided, so as to be elevated to an original work of art which fully expresses the intrinsic characteristics of a seal itself such as artistry and creativity.

### BRIEF DESCRIPTION OF DRAWINGS

FIG. 1 is a diagram illustrating the form of an auxiliary decoration formed on an auxiliary decorative portion prior to a decorative seal being formed on a decorative seal portion, in order to form an ornament formed with a decorative seal according to the present invention.

FIG. 2 is a diagram illustrating a decorative seal used in an ornament having a decorative seal formed thereon according to the present invention.

FIG. 3 is a diagram illustrating an ornament on which a decorative seal is formed on a decorative seal portion according to the present invention.

FIG. 4 is a diagram illustrating a main material and an auxiliary material for forming an ornament on which a decorative seal is formed according to the present invention.

### EXPLANATION OF REFERENCE NUMERALS AND SYMBOLS

10: Ornament on which decorative seal may be formed
11: Decorative seal portion
12: Auxiliary decorative portion
21: Decorative seal
30: Ornament on which decorative seal is formed
31: Decorative seal portion
32: Auxiliary decorative portion
40: Main material
50: Auxiliary material

### BEST MODE

Hereinafter, exemplary embodiments of the present invention will be described in detail with reference to the accompanying drawings. It should be noted that the same components refer to the same reference numerals anywhere as possible in the drawings, and the drawings attached to the present specification are not represented to scale but are enlarged and reduced in portions in order to convey the technical spirit of the invention.

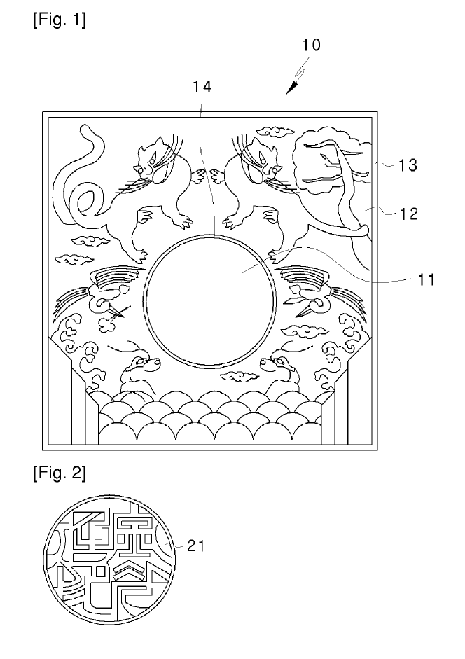

FIG. 1 is a diagram illustrating the form 10 of an auxiliary decoration formed on an auxiliary decorative portion prior to a decorative seal being formed on a decorative seal portion, in order to form an ornament formed with a decorative seal according to the present invention. While the decorative seal is not yet formed in FIG. 1, the form 10 illustrated in FIG. 1 may be used by itself as an original work of art or ornament such as for a gift.

An auxiliary decorative portion 12 is provided on the ornament 10 in FIG. 1 on which a decorative seal may be formed, and as exemplarily illustrated in FIG. 1, various designs or animal forms, etc. may be formed. For example, the shapes of the abstract legendary twin dragons symbolizing ascension to heaven or tigers that are actual animals symbolizing courage may be formed on the auxiliary decorative portion.

Also, a separate design may be preferably formed on a peripheral surface 13 of the auxiliary decorative portion 12 and form a boundary with the auxiliary decorative portion 12 so as to elevate the artistic value thereof.

In addition, while the material used for the auxiliary decorative portion 12 is generally a molded plate of a metal material, wood or animal bone may be used according to consumer tastes.

The auxiliary decoration of the auxiliary decorative portion 12 may preferably be formed with a carving method using embossing or intaglio techniques, and may even be formed with a printing technique.

Further, the auxiliary decoration of the auxiliary decorative portion 12 may preferably be formed by being patterned.

In addition, while the auxiliary decoration of the auxiliary decorative portion 12 may be formed manually by a professional seal maker, a molding technique may be used, or a technique employing computer technology is also possible.

Also, the surface of the auxiliary decorative portion 12 may be surface treated prior to forming the auxiliary decoration in order to improve etch resistance, wear resistance, and other physical and chemical properties of the metal surface, and may be preferably sanded to improve feel.

In addition, while the auxiliary decorative portion may have an auxiliary decoration of a single color, multiple colors may be used to elicit an aesthetic look.

The decorative seal portion 11 depicted with reference numeral 11 in FIG. 1 is provided within the auxiliary decorative portion 12, and preferably, in the center of the auxiliary decorative portion 12, in order to selectively form the decorative seal of the ornament according to the present invention according to the decorative use or a consumer's taste.

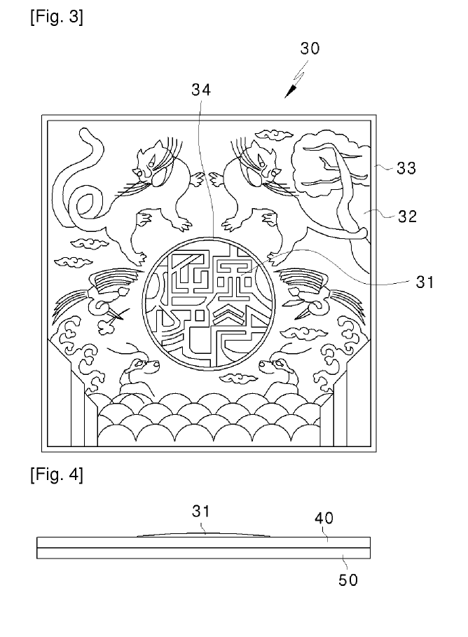

The decorative seal portion 11 may be formed to have a considerable difference in level with the auxiliary decorative portion 12 so that a separately manufactured decorative seal 21 as illustrated in FIG. 3 may be inserted into and combined with the decorative seal portion 11.

Further, it may be preferable to attach the decorative seal 21 to the decorative seal portion 11 by using an adhesive.

While generally formed on a molded plate of a metal material, the decorative seal 21 may be formed on wood or animal bone according to a consumer's taste.

The decorative seal 21 may preferably be formed with a carving method using embossing or intaglio techniques, and may even be formed with a printing technique.

Also, the decorative seal 21 may may be patterned and formed with multiple colors, but may preferably be formed with a single color.

Further, while the decorative seal 21 may be manually formed by a seal making professional, a molding technique may be used, or a technique employing computer technology may be used.

Also, the decorative seal portion 11 and the auxiliary decorative portion 12 may be formed on relatively the same level. In this case, a separately manufactured decorative seal 21 is not inserted and coupled to the decorative seal portion 11 and an adhesive is not used for attachment, but the decorative seal may be carved or patterned and formed directly on the decorative seal portion 11 manually or through computer technology.

In addition, a boundary portion 14 may be formed on the periphery of the decorative seal portion 11 so that the periphery of the decorative seal portion 11 and the auxiliary decorative portion 12 form a boundary.

Further, while generally round, the decorative seal portion 11 and the decorative seal 21 may be formed in another geometric shape such as a rectangle according to a consumer's selection or the decorative purpose.

When the decorative seal 21 in FIG. 2 is coupled to the ornament 10 on which the decorative seal in FIG. 1 may be formed, an ornament 30 on which a decorative seal is formed as in FIG. 3 is completed.

While the ornament in FIG. 1 or FIG. 3 may be used by itself as an ornament with artistic value, it may be coupled to an additional background ornament such as a frame to be used for decorative purposes, in which case, it is preferable to select the material of the ornament according to the present invention or the color of the decorative seal and/or the auxiliary decoration in order to match to the background ornament.

FIG. 4 is a diagram illustrating ornaments 10 and 30 according to the present invention formed by coupling a main material 40 and an auxiliary material 50 for reinforcing and supporting the main material. When the main material 40 of the ornaments 10 and 30 according to the present invention is formed as a thin plate, the plate may later bend, which would undermine the decorative purpose of the ornament. Therefore, the auxiliary material 50 for reinforcing and supporting the main material 40 may be attached to the rear surface of the main material 40 of the ornament.

Hereinafter, a method for manufacturing an ornament having a decorative seal according to the present invention will be described.

A method for manufacturing an ornament having a decorative seal according to the present invention includes: a step of forming an auxiliary decorative portion 12 on which an auxiliary decoration may be formed with various designs, a step of forming the auxiliary decoration on the auxiliary decorative portion 12 by carving or patterning manually or by means of a mold, a step of forming a decorative seal portion 11 for forming the decorative seal within the ornament, and a step of selectively carving or patterning the decorative seal on the decorative seal portion 11 according to the decorative purpose or a consumer's taste.

After a step is formed between the auxiliary decorative portion 12 and the decorative seal portion 11, the forming of a decorative seal with a separate material as in FIG. 3 may be further added to the step of inserting and coupling to the decorative seal portion 11.

Also, the step of forming the auxiliary decorative portion 12 may include a step of forming a decoration in a separate pattern on the peripheral surface 13 of the auxiliary decorative portion 12.

In addition, the step of forming the decorative seal portion 11 may include a step of forming a boundary 14 between the periphery of the decorative seal portion and the auxiliary decorative portion 12.

Further, the method for manufacturing an ornament having a decorative seal according to the present invention may further include a step of coupling a main material 40 for forming the decorative portions 11 and 12 to an auxiliary material 50 which is added to and supports the main material.

Moreover, the method for manufacturing an ornament having a decorative seal according to the present invention may form the main material 40 and the auxiliary material 50 as a die plate of a metal material or another material selected according to a consumer's taste.

Also, the method for manufacturing an ornament having a decorative seal according to the present invention may further include surface treating the surface of the main material 40 on which the decorative portions are formed in order to improve etch resistance, etc. of the surface, or sanding the surface in order to improve the feel thereof.

As described above, although certain exemplary embodiments of the present invention have been described in detail, it is to be understood by those skilled in the art that the spirit and scope of the present invention are not limited to the certain exemplary embodiments, but are intended to cover various modifications and changes without departing from the subject matter of the present invention. In particular, the vocabulary or terminology used in the present invention should not be interpreted as being limited to typical meanings or dictionary definitions, and the present inventors may suitably define the concepts of terminology to describe their invention in the best way possible. Thus, the vocabulary or terminology in the present invention should be interpreted in terms of meanings and concepts that conform to the technical subject matter of the present invention.

1. An ornament having a decorative seal and comprising:
a decorative seal portion on which the decorative seal is formed; and
an auxiliary decorative portion on which an auxiliary decoration is formed, and being formed around the decorative seal portion, wherein
the decorative seal is formed on the decorative seal portion by selectively carving or patterning according to a decorative purpose or a consumer's taste, and
the auxiliary decoration of various designs is formed on the auxiliary decorative portion by carving or patterning, manually or by means of a mold.

2. The ornament of claim 1, wherein the ornament comprises:
a main material for forming a decorative portion; and
an auxiliary material attached to and supporting the main material.

3. The ornament of claim 2, wherein the main material and the auxiliary material are formed of die plates which are made of a precious metal or a metal material or a material selected according to a consumer's taste.

4. A method for manufacturing an ornament having a decorative seal, the method comprising:
a step of forming an auxiliary decorative portion on which an auxiliary decoration is to be formed having various designs around the decorative seal;
a step of forming the auxiliary decoration on the auxiliary decorative portion by carving or patterning, manually or by means of a mold;
a step of forming a decorative seal portion for forming the decorative seal within the ornament; and
a step of forming the decorative seal on the decorative seal portion by selectively carving or patterning according to a decorative use or a consumer's taste.

5. The method of claim 4, further comprising a step of coupling a main material for forming the decorative portion, with an auxiliary material for attaching to and supporting the main material.

6. The method of claim 5, wherein the main material and the auxiliary material are formed of die plates of a metal material or a material selected according to a consumer's taste.

7. The method of claim 5, further comprising a step of sanding a surface of the main material on which the decorative portions are formed.
